(19) United States
(12) Patent Application Publication
(10) Pub. No.: US 2021/0141719 A1
(43) Pub. Date: May 13, 2021

(54) ASSERTION ENGINE FOR VALIDATING THE CONFIGURATION OF A TRANSACTION PROCESSING SYSTEM

(71) Applicant: Goldman Sachs & Co. LLC, New York, NY (US)

(72) Inventors: Angelos Anastasiou, London (GB); Jorge Luis Perea Ramos, London (GB); Oluwaseun Tofunmi Ogungbaigbe, London (GB)

(21) Appl. No.: 16/893,209

(22) Filed: Jun. 4, 2020

Related U.S. Application Data
(60) Provisional application No. 62/933,958, filed on Nov. 11, 2019.

(51) Int. Cl. G06F 11/36; G06Q 20/42

(52) U.S. Cl. CPC G06F 11/3688; G06F 11/3612; G06Q 20/42; G06F 11/3664; G06F 11/3696

(57) ABSTRACT

A stack validation system validates that a banking stack is configured to process transactions as intended. An engineering team may define assertions, that are converted into queries (e.g., in a JSON query language). Users may define test cases, including test payments and assertions selected from those defined by the engineering team, without further input from the engineering team. The test payments are processed by the banking stack and the queries corresponding to the selected assertions are run against the output from the banking stack. The system determines whether the banking stack passed or failed the assertions. The configuration of the stack may be verified and certified for production if the banking stack passed the assertions.

### CROSS-REFERENCE TO RELATED APPLICATIONS

This application claims the benefit of U.S. Provisional Application No. 62/933,958, filed Nov. 11, 2019, which is incorporated by reference.

### BACKGROUND

### Technical Field

The subject matter described relates generally to configuration testing and, in particular, to a platform for testing an entire banking stack in a repeatable, extensible, secure, and frictionless way.

### Backgroud Information

Existing approaches to validating the banking stack are siloed, with different approaches being used for different parts of the stack. This often results in multiple copies of the same or similar data being stored which may be hard to reconcile over time. Many existing approaches also rely on extensive manual review, which is prone to human error. These and other factors increase the risk that an incorrectly configured banking stack is deployed.

Furthermore, when parts of the banking stack are updating, creating corresponding validation approaches may be difficult and time consuming. This may result in delay in the roll out of improved transaction processing systems. Thus, there is a need for systems and methods for validating banking stacks that are holistic, reliable, and secure, that may also be extended or modified with little or no friction.

### SUMMARY

A stack validation system uses an orchestration engine to evaluate test cases to validate a banking stack. A test case includes one or more payments along with one or more assertions. An assertion is an individual instruction on how to validate a business flow (e.g., validate a payment is rejected by a payment system if the account information is incorrect). For example, a test case might include sending a payment with an invalid IBAN to validate that the payment orchestrator rejects invalid accounts. In various embodiments, the stack validation system separates the creation of assertions (which is an engineering concern) and the creation of test cases (which is a user concern). This separation may be useful because it releases the user from the task of learning technical language to be able to create test cases. In other words, the test case creation becomes something the user can conduct in a self-service fashion without need for technical assistance. Another benefit of this approach is that the user may be isolated from technology changes. Thus, at any point in time, the engineering team can enhance the assertions in a way that is entirely transparent for the user. One of skill in the art may appreciate other advantages to this approach.

The creation of a new assertion may be end-to-end data driven. This means that the new assertions may be added and made them available to users with the addition of configuration data in a database or other datastore used by the stack validation system. Once the data is added, new UI components may automatically be displayed to allow users to select the new assertion and include it in test cases. In addition, the assertion engine backend may also be able to perform the new validation without the need to extend its core code.

In one embodiment, a method for testing a banking stack of a transaction orchestrator includes receiving a request to test the transaction orchestrator that identifies a test case. The test case identifies one or more transactions and one or more assertions. The transactions are provided to the transaction orchestrator for processing and the output from the banking stack of the transaction orchestrator is received in responsive. The method also includes obtaining one or more queries corresponding to the one or more assertions and applying the queries to the output of the banking stack to generate query results. The configuration of the transaction orchestrator may be certified for production based on the query results.

### BRIEF DESCRIPTION OF THE DRAWINGS

FIG. 1 is a block diagram of a networked computing environment suitable for validating a banking stack, according to one embodiment.

FIG. 2 is a block diagram of the stack validation system of FIG. 1, according to one embodiment.

FIG. 3 illustrates a user interface for defining a test case, according to one embodiment.

FIG. 4 illustrates output from a payment orchestrator when testing a banking stack, according to one embodiment.

FIG. 5 is a flowchart of a method for validating a banking stack, according to one embodiment.

FIG. 6 is a block diagram illustrating an example computer suitable for use in the networked computing environment of FIG. 1, according to one embodiment.

### DETAILED DESCRIPTION

Reference will now be made to several embodiments, examples of which are illustrated in the accompanying figures. Wherever practicable, similar or like reference numbers are used in the figures to indicate similar or like functionality. Although specific embodiments of a system and method for validating a banking stack are described, one of skill in the art will recognize that the disclosed techniques may be applied in other ways and for validation of different types of stack.

### Example Systems

FIG. 1 illustrates one embodiment of a networked computing environment 100 suitable for developing, validating, and deploying a banking stack. In the embodiment shown, the networked computing environment 100 includes a developer system 110, a stack validation system 120, and a production system 130, all connected via a network 170. In other embodiments, the networked computing environment 100 may include different or additional elements. Furthermore, the functionality may be distributed in a different manner than described. For example, the functionality attributed to the developer system 110 and stack validation system 120 may be provided by a single computing device.

The developer system 110 is one or more computing devices with which a development team designs and builds a banking stack for an organization. The banking stack is configured to process transactions. Typically, the banking stack performs multiple steps in a specified order to process a transaction. Each step outputs results and the results of at least some of the steps determine whether the transaction should be approved or denied. For example, one step may check that the parties to the transaction are not subject to sanctions that should result in the transaction being denied. Another step may verify that the payor has sufficient funds available to complete the transaction, etc. As regulations, business goals, user demands, available technology, best practices, and other factors evolve, the development team will typically update the banking stack to meet the organization's demands.

The stack validation system 120 is one or more computing systems configured to test the banking stack to determine whether it meets user requirements. In various embodiments, the stack validation system 120 enables a user to define a test case including one or more assertions and one or more test transactions. The stack validation system processes the text transactions using the banking stack and determines whether the resulting output is consistent with the requirements of the assertions. The stack validation system 120 may present the results of applying the assertions to the output to the user, who can decide whether to certify the banking stack as ready for production, perform additional tests, or send it back the development team for additional development. In some embodiments, if the stack validation system 120 determines there are no issues to resolve, the banking stack may be automatically certified. Various embodiments of the stack validation system 120 are described in greater detail below, with reference to FIG. 2.

Once the banking stack is certified as ready for production, it may be provided to the production system 130. The production system includes one or more computers that process actual transactions using the banking stack. For example, the production system 130 may be a transaction orchestration platform operated by a bank or other financial institution. The newly certified banking stack may be used to supplement or replace the existing banking stack on the production system 130 (or, in the case of a new or previously disabled system, bring it online).

The network 170 provides the communication channels via which the other elements of the networked computing environment 100 communicate. The network 170 can include any combination of local area and/or wide area networks, using both wired and/or wireless communication systems. In one embodiment, the network 170 uses standard communications technologies and/or protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). All or some of the communication links of the network 170 may be encrypted using any suitable technique or techniques.

FIG. 2 illustrates one embodiment of the stack validation system 120. In the embodiment shown, the stack validation system 120 includes an assertion definition module 210, a test case module 220, an orchestration engine 230, an assertion engine 240, a payment orchestrator 250, an assertions datastore 260, a test cases datastore 270, and a results datastore 280. In other embodiments, the stack validation system 120 may include different or additional elements. Furthermore, the functionality may be distributed in a different manner than described. For example, although the payment orchestrator 250 is shown for illustrative purposes as part of the stack validation system 120, it may be a separate computing system that communicates with the stack validation system via the network 170.

The assertion definition module 210 enables an engineering team to define and configure assertions for validating business flows. Engineering team is used broadly in this context to refer to one or more people responsible for encoding the business flows into assertions. In one embodiment, the engineering team sources the business flows to be validated from users of the banking stack and defines a set of steps or processes for validating the business flows, with each step or process being an assertion against which the performance of the banking stack may be tested to determine whether it passes of fails the requirements of the assertion. The assertions may be translated into executable queries (e.g., in a JSON query language) and stored in the assertions data store 260. Thus, after an initial configuration phase involving the engineering team, the users may apply the stored assertions to validate the configuration of a banking stack without further involvement of the engineering team. Additionally or alternatively, the engineering team my define or configure assertions on a periodic or on-going basis.

The test case module 220 enables users to define test cases with which to test the banking stack. A test case may include one or more test payments and one or more assertions. In one embodiment, the test case module 220 provides a user interface (UI) with which the user can create and edit test cases by selecting test payments and assertions. The assertions may be selected from those stored in the assertions datastore 260. The payments may identify a payor, a payee, an amount, a currency, and any other suitable information regarding a transfer of value using the banking stack. Although the term test payment is used for convenience, one of skill in the art will recognize that other types of transactions may be processed by a stack and similar techniques used to validate that the transactions are being processed as desired by the stack.

FIG. 3 illustrates an example UI for defining a test case. In the embodiment shown, the user may provide identifying information for the test case such as a name, select a type (e.g., from a list of options in dropdown menu), and identify one or more test suites with which the test case will be used (e.g., again by selecting from a dropdown menu). In a first step the user may define one or more test payments (e.g., by entering the appropriate details, or loading a previously defined set of test payments). In a second step, the user may select one or more assertions from those available. On selection of an assertion, the user may be presented with information describing the assertion and the option to confirm or reject its inclusion in the test case. In some embodiments, the user may toggle between the first and second steps (e.g., by clicking on the desired step in the list). When the user has completed defining the test case, they may execute is (e.g., by selecting a play button).

Note that for the test case shown in FIG. 3, the user selected twelve assertions. As an example, one of the assertions is called “Fircosoft No Hit” (Fircosoft is a system that is called in the payment orchestration flow to validate sanctions). During execution of this test case, the orchestration engine 230 sends the test messages to the payment orchestrator 250, and the assertion engine 240 executes the corresponding queries on the payment orchestrator output. Additional examples of assertions include validating debit and credit account postings depending on the business flow (this may be different for same-currency versus multi-currency transactions), validating the format of payment messages produced by the banking stack, validating the selection of method of payment (e.g., local clearing vs correspondent banking vs internal book movement), validating the content of produced acknowledgment files (these are files produced by the banking stack as a response to incoming payment instructions), validating the credit check request and response generated by the banking stack is correct, validating the attributes of FX transactions (e.g., settlement date and FX provider), etc. One of skill in the art will recognize that many assertions may be defined to confirm the banking stack is processing transactions as intended.

In some embodiments, once a test case has been defined, it is saved (e.g., in the test cases store 270). Thus, rather than defining a new test case every time a banking stack is tested, user may load previously defined test cases and execute them as many times as desired. Furthermore, users may load test cases and then edit them to create new test cases. Because the process of creating test cases involves defining test payments and selecting premade assertions, it may be performed by users without the need to further engage with the engineering team.

Referring back to FIG. 2, when a test case is executed, the orchestration engine 230 sends the test payments to the payment orchestrator 250 for processing. The payment orchestrator 250 applies the banking stack being tested to process the payments and returns its output to the orchestration engine 230. In one embodiment, the output of the payment orchestrator 250 is in JSON format. The orchestration engine 230 retrieves the assertions selected for the test case (e.g., from the assertions datastore 260) and builds a query set for the test case (e.g., the JSON query generated from each selected assertion). In another embodiment, definitions of the assertions may be stored in another format (e.g., in the assertions datastore 260) and the assertion engine 240 may build the queries from the stored definitions of the assertions.

Regardless of exactly how the set of queries is obtained, the assertion engine 240 applies the queries to the output of the payment orchestrator 250. Each query identifies a string or value (or set of strings or values) that are expected to be in the output from the payment orchestrator 250 if the banking stack is processing the test payments correctly. If the identified string or value for a given assertion is found in the output, the assertion engine 240 marks that assertion as passed. Thus, the assertion engine 240 may determine whether the banking stack passes or fails each assertion. FIG. 4 illustrates the application of a query to the output of the payment orchestrator 250, according to one embodiment.

As shown in FIG. 4, an assertion is represented as a JSON path query 410. The query 410 is run against the payment orchestrator output 420. In this case, the expected string 430 was found in the output. Therefore, the assertion engine 240 determines that the banking stack under test has passed that assertion. The assertion engine 240 may store the results of applying the query 410 to the payment orchestrator output 420 in the results datastore 280 (e.g., as a list of assertions applied and an indication of whether each was passed or failed).

In particular, FIG. 4 illustrates the applying the “Fircosoft No Hit” assertion selected in FIG. 3. For this assertion, the user expects that each of the ten payments of the test case should be screened for sanctions (hence the need to validate against Fircosoft) and that none of them should be flagged as problematic (“No Hit” means that the payments are not directed to a sanctioned beneficiary). In particular, in the embodiment shown, the assertion engine 240 has translated the user selection in the UI of the “Fircosoft No Hit” assertion to a JSON query. This query identifies content that is expected to be present in the payment orchestrator output to validate that the payments were flagged as “No Hits” (i.e., that the payment should not be blocked for being to a sanctioned entity). When the test case in executed, the assertion engine 240 applies the query to the payment orchestrator output and, in this case, determines the expected content is present. Thus, the assertion is marked as passed.

Referring back to FIG. 2, in one embodiment, the assertion engine 240 displays the results to the user in a UI. The user may validate the results (e.g., by checking that portions of the payment orchestrator output 420 that match the queries represent desirable behavior of the banking stack rather than coincidence). If the user determines that all of the tests were passed and sufficient testing has occurred, the user may validate the banking stack and it can be released to the production system 130 for deployment. Alternatively, the user may execute additional test cases against the banking stack to gather further data or elect to send the banking stack back to the responsible technology team for further work. For example, if the banking stack is failing particular assertion because it is not processing transactions correctly, the user can flag the error and request the appropriate technology team fix it. Once an updated version of the banking stack is provided by the development team, the user may test it again. This process may be repeated until the user is satisfied that the banking stack is ready for deployment. In embodiments where the test cases are stored, the user may efficiently retest the updated banking stack by loading and re-executing the previously used test cases.

The assertions data store 260, test cases datastore 270, and results datastore 280 include one or more computer readable media configured to store data used by the stack validation system 120. Although they are shown as distinct elements, two or more of them may be combined into a single datastore (e.g., a single system database). Furthermore, although they are shown as part of the stack validation system 120, some or all of the data may be stored remotely (e.g., in a distributed database) and accessed via the network 170.

### Example Banking Stack Validation Methods

FIG. 5 illustrates an example method 500 for validating a banking stack. The steps of FIG. 5 are illustrated from the perspective of the stack validation system 120 performing the method 500. However, some or all of the steps may be performed by other entities or components. In addition, some embodiments may perform the steps in parallel, perform the steps in different orders, or perform different steps.

In the embodiment shown in FIG. 5, the method 500 begins by defining 510 a set of assertions. As described previously, an engineering team can collaborate with users to determine various steps for validating one or more business flows (e.g., processing of transactions of different types or using different orchestration platforms) and encode these steps and processes into modular assertions. Each assertion may define a query that may be applied to the output from a payment orchestrator 250 to determine whether it is performing a particular processing step correctly.

The stack validation system 120 receives 520 a selection of one or more assertions and test payments for use as a test case. The test case may be defined by a user using a UI, such as the one shown in FIG. 3. The test payments are processed 530 by a payment orchestrator 250, which generates payment orchestrator output.

The stack validation system 120 also generates 540 a set of one or more validation queries from the selected assertions. As described previously, the validation queries may be retrieved from a datastore (e.g., the assertions datastore 260) by looking up the queries associated with the selected assertions (or generated at run time based on a definition of the assertion stored in another format).

The stack validation system 120 applies 550 the validation queries to the payment orchestrator output to generate results. The stack validation system 120 determines whether to validate the banking stack used by the payment orchestrator 250 to process the test payments based on the results. For example, as described previously, results indicating whether each assertion was passed or failed can be presented to a user in a UI, and the user can determine whether to certify the stack or return it to one or more technology teams for further development.

### Example Computing Device Architecture

FIG. 6 illustrates an example computer 600 suitable for use in the networked computing environment 100 of FIG. 1 as (or as part of) a developer system 110, a stack validation system 120, or a production system 130. The example computer 600 includes at least one processor 602 coupled to a chipset 604. For clarity, operations may be described as being performed by “a processor,” but this should be understood to include multiple processors working cooperatively to perform the recited operations. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

In the embodiment shown in FIG. 6, the storage device 608 is a non-transitory computer-readable medium such as a hard drive, compact disk read-only memory (CD-ROM), DVD, or solid-state memory device. The memory 606 holds instructions and data used by the processor 602. While the storage device 608 is shown to be a single medium, the term “machine-readable medium” should be taken to include a single medium or multiple media (e.g., a centralized or distributed database, or associated caches and servers) configured to store data or software used by the computer 600. For example, the data stores used by the stack validation system 120 may be implemented as a distributed database provided by multiple servers and accessed via the network 170.

The pointing device 614 is a mouse, track ball, touch-screen, or other type of pointing device, and is used in combination with the keyboard 610 (which may be an on-screen keyboard) to input data into the computer system 600. The graphics adapter 612 causes the display 618 to display images and other information. The network adapter 616 couples the computer system 600 to one or more computer networks, such as the internet. In some embodiments, a computer can lack some of the components described above, such as a keyboard 610, pointing device 614, or display 618.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise. Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate alternative structural and functional designs for a system and a process for validating the configuration of a banking stack. For instance, server processes may be implemented using a single server or multiple servers working in combination, databases and applications may be implemented on a single system or distributed across multiple systems, and distributed components may operate sequentially or in parallel. Thus, while particular embodiments and applications have been illustrated and described, the scope of protection should be limited only by any claims that issue.

What is claimed is:

1. A method for testing a transaction orchestrator, the method comprising:
receiving a request to test the transaction orchestrator, the request identifying a test case that includes one or more transactions and one or more assertions;
obtaining one or more queries corresponding to the one or more assertions;
providing the one or more transactions to the transaction orchestrator for processing;
receiving output generated by the transaction orchestrator responsive to processing the one or more transactions;
applying the one or more queries to the output to generate query results; and
validating the transaction orchestrator configuration based on the query results.

2. The method of claim 1, wherein the one or more transactions comprise test payments.

3. The method of claim 1, wherein the one or more queries comprise JSON path queries.

4. The method of claim 1, further comprising:
displaying a user interface (UI) including controls for selecting assertions from a predetermined set of available assertions; and
receiving, via the controls of the UI, user input selecting the one or more assertions,

5. The method of claim 4, wherein the UI further includes a control to initiate the test and the method further comprises receiving an indication of user-selection of the control to initiate the test, wherein the request to test the payment orchestrator system is generated responsive to receiving the indication.

6. The method of claim 1, wherein validating the transaction orchestrator configuration comprises:
determining whether the transaction orchestrator passed the assertions from the query results;
validating the transaction orchestrator configuration responsive to the transaction orchestrator passing the assertions.

7. The method of claim 6, wherein determining whether the transaction orchestrator passed the assertions comprises, for each assertion:
running the query corresponding to the assertion against the output generated by the transaction orchestrator; and
marking the assertion as passed responsive to the query returning a result.

8. The method of claim 1, further comprising:
defining a plurality of predetermined assertions; and
storing the plurality of predetermined assertions in a datastore,
wherein the one or more assertions are selected from among the plurality of predetermined assertions.

9. The method of claim 8, wherein the predetermined assertions are defined by an engineering team and the test case is defined by a user, without additional input from the engineering team.

10. The method of claim 1, further comprising deploying a banking stack of the transaction orchestrator for productions responsive to validating the configuration of the transaction orchestrator.

11. A non-transitory computer-readable medium comprising stored instructions for testing a transaction orchestrator, the instructions when executed by a computing device, causing the computing device to perform operations including:
receiving a request to test the transaction orchestrator, the request identifying a test case that includes one or more transactions and one or more assertions;
obtaining one or more queries corresponding to the one or more assertions;
providing the one or more transactions to the transaction orchestrator for processing;
receiving output generated by the transaction orchestrator responsive to processing the one or more transactions;
applying the one or more queries to the output to generate query results; and
validating the transaction orchestrator configuration based on the query results.

12. The non-transitory computer-readable medium of claim 11, wherein the one or more transactions comprise test payments and the one or more queries comprise JSON path queries.

13. The non-transitory computer-readable medium of claim 11, wherein the operations further include:
displaying a user interface (UI) including controls for selecting assertions from a predetermined set of available assertions; and
receiving, via the controls of the UI, user input selecting the one or more assertions,

14. The non-transitory computer-readable medium of claim 13, wherein the UI further includes a control to initiate the test and the method further comprises receiving an indication of user-selection of the control to initiate the test, wherein the request to test the payment orchestrator system is generated responsive to receiving the indication.

15. The non-transitory computer-readable medium of claim 11, wherein validating the transaction orchestrator configuration comprises:
determining whether the transaction orchestrator passed the assertions from the query results;
validating the transaction orchestrator configuration responsive to the transaction orchestrator passing the assertions.

16. The non-transitory computer-readable medium of claim 15, wherein determining whether the transaction orchestrator passed the assertions comprises, for each assertion:
running the query corresponding to the assertion against the output generated by the transaction orchestrator; and
marking the assertion as passed responsive to the query returning a result.

17. The non-transitory computer-readable medium of claim 11, wherein the operations further include:
defining a plurality of predetermined assertions; and
storing the plurality of predetermined assertions in a datastore,
wherein the one or more assertions are selected from among the plurality of predetermined assertions.

18. The non-transitory computer-readable medium of claim 17, wherein the predetermined assertions are defined by an engineering team and the test case is defined by a user, without additional input from the engineering team.

19. The non-transitory computer-readable medium of claim 11, wherein the operations further include deploying a banking stack of the transaction orchestrator for productions responsive to validating the configuration of the transaction orchestrator.

20. A transaction orchestrator configuration validation system comprising:
a test case module configured to define a test case, the test case identifying one or more transactions and one or more assertions;
an orchestration engine configured to provide the one or more transactions to a transaction orchestrator for processing; and
an assertion engine configured to:
obtain one or more queries corresponding to the one or more assertions;
receive output generated by the transaction orchestrator responsive to processing the one or more transactions;
apply the one or more queries to the output to generate query results; and
validate the transaction orchestrator configuration based on the query results.
